(19) United States
(12) Patent Application Publication
(10) Pub. No.: US 2024/0320397 A1
(43) Pub. Date: Sep. 26, 2024

(54) Method to classify, design and manufacture a metallic part

(71) Applicant: ArcelorMittal, Luxembourg (LU)

(72) Inventors: Nicolas SCHNEIDER, Saint Martin Longueau (FR); Alexandre BLAISE, Montataire (FR); Elie GIBEAU, Pont-Sainte-Maxence (FR)

(21) Appl. No.: 18/575,847

(22) PCT Filed: Jul. 8, 2022
(86) PCT No.: PCT/IB2022/056322

§ 371 Date: Dec. 31, 2023

(30) Foreign Application Priority Data
Jul. 12, 2021 (WO) PCT/IB2021/056234

(51) Int. Cl. G06F 30/23; G06F 113/24; G06F 119/18

(52) U.S. Cl. CPC G06F 30/23; G06F 2101/14; G06F 2113/24; G06F 2119/18

(57) ABSTRACT

A computerized method to determine the aptitude of a metallic part to be manufactured by roll forming and to classify metallic parts into one of the following categories: roll-formable without modification, roll-formable with modifications, not roll-formable. It also provides for a computerized method to compute the roll forming direction of a part. It further provides a method for determining the aptitude to roll forming of a large set of parts, such as for example part of the set of parts making up an automotive vehicle. The purpose of the current invention is further to provide a manufacturing method for a metallic part.

The present invention relates to the manufacture of metallic parts and in particular to the forming of metal parts from metallic sheets, such as for example steel or aluminum sheets.

### BACKGROUND

There exist several known processes to form metallic sheets into parts: stamping, crash forming, bending, roll forming, etc. Out of all these processes, roll forming yields many advantages:
very high productivity thanks to its continuous nature and direct coil to part processing route,
very tight geometrical tolerances thanks to the progressive nature of the forming sequence,
the possibility to form parts of very high strength material, possibly with low elongation, thanks to the fact that the material is deformed progressively by bending and thanks to its ability to efficiently handle springback issues,
the possibility to easily manufacture very long parts, thanks to the limitless length of the process,
a flexible approach to part design, thanks to the fact that the roll forming sequence can easily be changed by adjusting the stands or by adding/removing stands—in contrast with stamping for example in which the stamping tools fix the shape of the final part and cannot easily be adjusted,
an energy efficient forming technique, addressing the challenges of reduced energy consumption in manufacturing parts.

Thanks to these numerous advantages, roll forming can increase productivity, reduce costs and also contribute to addressing the overall environmental challenges to which part manufacturers are confronted, such as reducing energy consumption and CO₂ emissions. Furthermore, in the field of automotive manufacturing, roll forming allows to produce very high strength structural parts with high strength metals, thereby addressing the combined challenges of vehicle weight reduction for reduced fuel/electricity consumption and increased passenger safety.

### SUMMARY OF THE INVENTION

Because of the specific nature of the process, roll forming can only be applied on parts having a uniform section. In the case of parts having a close to uniform cross section, the part can be manufactured by roll forming with small modifications either to the initial design of the part, to make it fully roll-formable, or to the manufacturing process of the part, by applying some additional processing steps either before or after the roll forming operation itself.

One purpose of the current invention is to provide a computerized method to determine the aptitude of a metallic part to be manufactured by roll forming and to classify metallic parts into one of the following categories: roll-formable without modification, roll-formable with modifications, not roll-formable. It is also a purpose of the current invention to provide a computerized method to compute the roll forming direction of a part. It further provides a method for determining the aptitude to roll forming of a large set of parts, such as for example part of the set of parts making up an automotive vehicle.

An alternate or additional purpose of the current invention is further to provide a manufacturing method for a metallic part.

The present invention provides a method for the computerized determination of a roll formability index R %, and of a roll forming direction Rdir of a metallic part, comprising the following steps:
providing a finite element mesh of said metallic part,
Computing for each element i of said mesh the vector \vec{V}ᵢ defined as the product of the normal vector of said element i by the surface area of said element I,
Generating the matrix V of all vectors Vi,
Performing a singular value decomposition of said matrix V in the form of

V=U·Σ·Y
Extracting the smallest singular value Σmin=min(Σii) of said singular value decomposition,
Computing the sum of the main diagonal of Σ, Σsum=Σ₁₁+Σ₂₂+Σ₃₃
Computing the roll formability index of the part R % as being

$$R \% = 300 * ( \frac{1}{3} - \frac{\sum min}{\sum sum} )$$

Extracting the roll forming direction Rdir as being the direction of the vector Ymin having the set of coordinates (Yi1, Yi2, Yi3) wherein i is the index for which Σii=Σmin.

### BRIEF DESCRIPTION OF THE DRAWINGS

The invention will now be described in detail and illustrated by examples without introducing limitations, with reference to the appended figures:

FIG. 1 is a graphic illustration of the singular value decomposition of a real m*3 matrix

FIG. 2 is a graphic representation of the Rfull and Rmod determination method of the current invention

### DETAILED DESCRIPTION

Roll forming is a continuous metal forming process taking a sheet, a strip, or a coil and bending or forming it to a continuous cross section. The process is performed between successive pairs of rolls that change the shape until the desired section is completed. Said section is called the roll forming section and the direction in which the material is being roll formed, i.e. the direction separating two successive pairs of rolls, is called the roll forming direction.

A part is said to be fully roll formable if the part can be manufactured using a roll forming process and without modifying its design.

A part is said to be roll formable with modifications in the following cases (possibly using a combination of the two cases):
either the part becomes fully roll formable once the design of said part has been modified through geometrical alterations
or the part can be manufactured using roll forming and by applying some additional processing steps either before or after the roll forming operation itself—said processing steps can involve for example punching, bending, embossing or any other post processing steps to the roll formed part.
in either case, the part after design modifications and/or post-processing still satisfies the packaging conditions (i.e. the physical integration of the part in its environment, for example in relationship to the other surrounding parts of the vehicle in the case of an automotive vehicle) and functional purposes of the initial part.

A part is said to be not roll formable if it is neither fully roll formable nor roll formable with modifications. In particular, a part is said to be not roll formable if the modifications necessary to render it roll formable would affect its packaging conditions (i.e. it would not fit with its surrounding parts) or its functional purpose.

A finite element mesh is a subdivision of a continuous geometric space into discrete elements.

In the current invention, a matrix of m three-dimensional vectors is defined as being the m*3 matrix for which each line is the set of coordinates of one of the m vectors.

A scalar product or dot product of two vectors is the sum of the product of their respective coordinates.

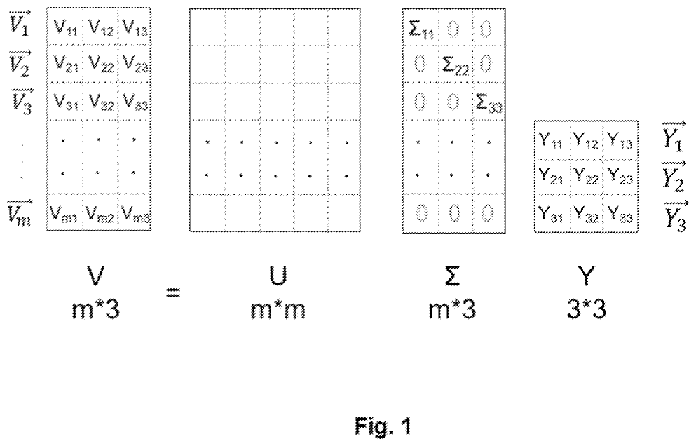

As illustrated in FIG. 1, the singular value decomposition of a real m*3 matrix of vectors V is the known factorization of said matrix in the form V═U·Σ·Y, wherein:
U is an m*m orthogonal matrix (i.e. having rows and columns representing a set of mutually orthogonal vectors all having unit length),
Σ is an m*3 diagonal matrix (i.e. having all entries outside of the main diagonal equal to 0) having non-negative numbers on its main diagonal,
Y is a 3*3 orthogonal matrix.

A gaussian probability distribution curve, or normal distribution curve, is the probability distribution curve G(x), associated to a population having an average value A and a standard distribution value SD, and having the following probability density function:

$$G ( x ) = \frac{1}{S D * \sqrt{2 π}} * {e}^{- \frac{1}{2} {( \frac{x - A}{S D} )}^{2}}$$

A roll formability index, R %, is defined as being a value estimating the aptitude of a metallic part to be manufactured using roll forming. R % is comprised between 0% and 100%. An R % of 0% represents the case of a part which has absolutely no possibility of being manufactured by roll forming—in effect R %=0% corresponds for example to the case of a fully spherical part, i.e. a fully isotropic part, having absolutely no preferential direction which could be used as the roll forming direction. On the other hand, a part having R %=100% has a fully uniform cross section all along the part when travelling from one end of the part to the other end of the part following a direction which will be the roll forming direction. In between these two extreme R % values, lies a continuous spectrum of roll formability indexes representing an increasing aptitude to be manufactured by roll forming as R % increases.

The current invention discloses a method for the computerized determination of this roll formability index R % of a metallic part and further allows to determine the roll forming direction Rdir of a metallic part. The method comprises the following steps:
providing a finite element mesh of said metallic part,
Computing for each element i of said mesh the vector Vi defined as the product of the normal vector of said element i by the surface area of said element i,
Generating the matrix V of all vectors Vi,
Performing a singular value decomposition of said matrix V in the form of

V=U·Σ·Y
Extracting the smallest singular value Σmin=min(Σii) of said singular value decomposition,
Computing the sum of the main diagonal of Σ, Σsum=Σ₁₁+Σ₂₂+Σ₃₃
Computing the roll formability index of the part R % as being

$$R \% = 300 * ( \frac{1}{3} - \frac{\sum min}{\sum sum} )$$

Extracting the roll forming direction Rdir as being the direction of the vector Ymin having the set of coordinates (Yi1, Yi2, Yi3) wherein i is the index for which Σii=Σmin.

Thanks to this computerized method, it is possible to determine the roll formability index R % and the roll forming direction Rdir of a part very rapidly, in a reliable way and without the need of specialized know-how. It is also possible to apply the method on a great many number of parts and obtain rapid results. This allows optimization and generalization of the use of roll forming on a set of parts.

Taking advantage of this method, the current invention further discloses a method for the computerized classification of a metallic part into one of the following categories: roll-formable without modification, roll-formable with modifications, not roll-formable, said method comprising the following steps:
providing pre-determined thresholds Rfull and Rmod, respectively defined as the minimum roll formability index of fully roll formable parts and as the minimum roll formability index of parts which are roll formable with modifications,
computing the roll formability index R % of said metallic part according to the above described method,
classifying the part into the fully roll formable category if R %>Rfull,
classifying the part into the roll formable with modifications category if Rfull≥R %≥Rmod,
classifying the part into the not roll formable category if R %<Rmod.
outputting the results to a user.

Thanks to this computerized classification method, it is possible to determine if a metallic part is roll formable with or without modifications or not roll formable at all in a reliable way and without the need of specialized know-how. It is also possible to apply the method on a great many number of parts and obtain rapid results. This allows optimization and generalization of the use of roll forming on a set of parts.

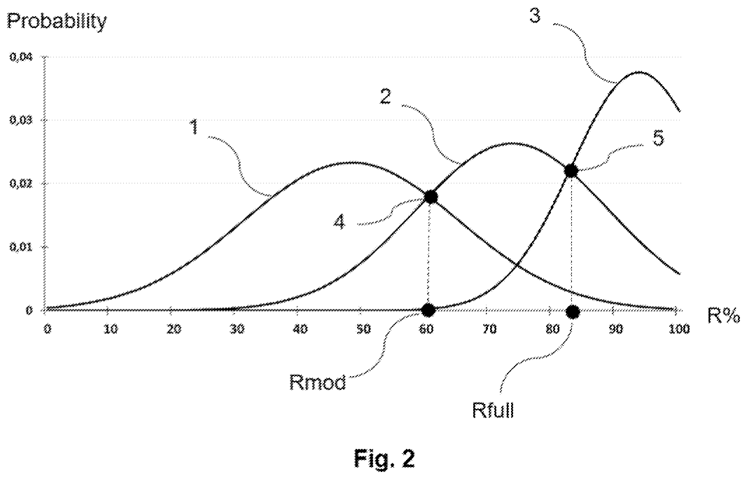

Referring to FIG. 2, the present invention also provides a method to determine the thresholds Rfull and Rmod to be used in the above computerized classification method, comprising the following steps:
providing a database MP of metallic parts
providing an expert team, comprising at least one expert in sheet metal forming
classifying the metallic parts of MP in three categories by the expert team: fully roll formable, roll formable with modifications, not roll formable
applying the above described method to determine the roll formability index R % of the metallic parts of MP
generating a database D associating for each metallic part of MP the above described classification performed by the expert team and the above computed roll formability index R %
computing the average and standard distribution of the R % values of D for each of the above described categories, said values being respectively known as A (fully roll formable), A (roll formable with modifications), A (not roll formable) for the average values and SD (fully roll formable), SD (roll formable with modifications), SD (not roll formable) for the standard deviation values,
generating the gaussian probability distribution curves of R % for each of the above computed average and standard deviations, said curves being respectively known as G(fully roll formable), G(roll formable with modifications), G(not roll formable),
determining Rfull as being the R % value at the intersection between G(fully roll formable) and G(roll formable with modifications),
determining Rmod as being the R % value at the intersection between G(roll formable with modifications) and G(not roll formable),
outputting the results to a user.

FIG. 2, depicts the gaussian probability distribution curves G(not roll formable), G(roll formable with modifications) and G(fully roll formable), respectively corresponding to references 1, 2 and 3. Reference 4 corresponds to the intersection between G(not roll formable) and G(roll formable with modifications), the R % value of reference 4 is Rmod. Reference 5 corresponds to the intersection between G(roll formable with modifications) and G(fully roll formable), the R % value of reference 5 is Rfull. As can be seen on FIG. 2, Rmod actually corresponds to the R % value below which the probability of a part to be judged not roll formable by the team of experts is higher than the probability of the part to be judged roll formable with modifications-conversely, Rmod corresponds to the R % value above which the probability of a part to be judged roll formable with modifications by the team of experts is higher than the probability of the part to be judged not roll formable. In a similar way, Rfull actually corresponds to the R % value below which the probability of a part to be judged roll formable with modifications by the team of experts is higher than the probability of the part to be judged fully roll formable—conversely, Rfull corresponds to the R % value above which the probability of a part to be judged fully roll formable by the team of experts is higher than the probability of the part to be judged roll formable with modifications. As a consequence, the three R % ranges 0%-Rmod, Rmod-Rull and Rfull-100% correspond respectively to the ranges of highest probability of a part to be judged not roll formable, roll formable with modifications and fully roll formable by the team of experts.

This method allows determination in a reliable way, based on the opinion of sheet metal forming experts, of the thresholds to be used in the above described computerized classification method. Thus, after having determined said thresholds, it will be possible to apply the above described computerized classification method to obtain classification results reflecting the opinion of sheet metal forming experts but without needing the active involvement of said experts. This allows to take full advantage of the computerized character of the classification method (fast, reliable, able to treat big quantities of data in a short amount of time) and at the same time to reflect the expertise of the expert team. This therefore allows to develop, generalize and optimize the use of roll forming on a set of parts.

For example, the database MP includes at least 50 metallic parts. More preferentially the database MP includes at least 100 metallic parts. Even more preferentially, the database MP includes at least 200 metallic parts. Advantageously, the higher the number of metallic parts included in the database MP, the more reliable the expert team's assessment will be and the more the results of the above described Rfull and Rmod will be representative of the different types of metallic parts to be classified.

For example, the expert team consists of one sheet metal forming expert. Preferentially, the expert team consists of at least two sheet metal forming experts. More preferentially, the expert team consists of at least three sheet metal forming experts.

The inventors have applied the above described method to determine Rmod and Rfull using a database of 126 metallic parts and a team of three sheet metal forming experts. The above described method allowed to determine Rmod=60% and Rfull=83%. In a particular embodiment, the above described computerized classification method is applied using Rmod=60% and Rfull=83%.

The current invention further provides for a method to classify at least part of the metallic parts of an automotive vehicle into one of the following categories: roll-formable without modification, roll-formable with modifications, not roll-formable, said method comprising the following steps:
providing a database AV of said metallic parts,
applying the above described computerized classification method to the metallic parts of AV,
generating a database AVC associating the metallic parts of AV with their respective classification obtained in the above step,
outputting the result to a user.

Thanks to this method, it is possible to evaluate rapidly the potential to apply roll forming over a large number of parts of a vehicle without the need of a specialized know-how. This allows optimization and generalization of the use of roll forming on an automotive vehicle.

The current invention also provides for a method to manufacture a metallic part comprising the following steps:
Classifying said metallic part in a category according to the above described computerized classification method,
Manufacturing the part using roll-forming if the part is classified in the roll formable category or in the roll formable with modification category.

This allows to manufacture metallic parts using roll forming whenever this forming technology can be applied.

The current invention further provides a method to manufacture a metallic part using roll forming comprising the following steps:
providing a set N of n different possible designs for said metallic part,
applying the above described computerized classification method to said possible designs,
generating the sub-set P of the p possible designs falling into the category fully roll formable or roll formable with modifications,
manufacturing the metallic part having a design included in sub-set P using roll forming.

This allows selection of a design for a part which allows manufacturing using roll forming and to manufacture the part using roll forming. This allows optimization the use of roll forming when there are several possible designs for a part.

The present invention further provides for a computer-aided method for numerical forming simulation of a metallic part comprising the following steps:
computing the roll formability index R % and the roll forming direction Rdir, according to the above described method,
applying the above described computerized classification method,
If the metallic part belongs to the category fully roll formable or roll formable with modifications:
   generating a roll forming section as being a cross-section of the metallic part according to a plane having the normal direction Rdir,
   generating a roll forming process simulation adapted to manufacture said roll forming section,
   outputting the result to a user,
if the metallic part belongs to the category not roll formable:
   informing a user that the metal part cannot be manufactured using roll forming

The present invention further provides a method to improve the roll formability

index of a metallic part, comprising the following steps:
providing a finite element mesh of said metallic part,
Computing for each element i of said mesh the vector Vi defined as the product of the normal vector of said element i by the surface area of said element i,
Generating the matrix V of all vectors Vi,
Applying the above described method to determine the roll forming direction Rdir
Normalizing each vector Vi to the vector V1i having unit length,
For each vector V1i, computing the scalar product Si of V1i and the unit length vector having Rdir as a span,
Providing a numerical threshold Thind, defined as being the numerical value such as when the absolute value of Si is greater than Thind then the element i is a hindrance to the roll formability of the part.
For each element i having Si>Thind, highlight as “hindrance to roll formability” the corresponding cross section of the metallic part according to the plane normal to Rdir
output the results of all the “hindrance to roll formability” cross sections to a user

Thanks to this method, the user will be informed of which areas of the part are a hindrance to roll formability and can make modifications to the metallic part's design in order to improve its roll formability. Such modifications can be for example comprised in the following list and can also be a combination of these possibilities:
cut the metallic parts into several different part according to a cutting plane defined by one or several “hindrance to roll formability” cross section. This allows to generate several different sub parts of the metallic part which will individually have improved roll formability, since the “hindrance to roll formability” sections have been severed out.
modify the design of the metallic part in the cross sections which are identified as a hindrance to roll formability to bring the orientation of all the elements i of said cross section as parallel as possible to the roll forming direction Rdir
modify the design of the metallic part to render it roll formable and combine the thus obtained roll formed part with additional elements manufactured using other means such as for example using additive manufacturing to add features directly on the roll formed part.

The present invention further provides for an iterative computerized method to modify the design of a part in order to increase the roll forming index of said part, comprising the following steps: A/ Providing a finite element mesh of said metallic part,
B/ Providing a targeted roll formability index R %_target,
C/ Modifying the finite element mesh of said metallic part in order to increase the roll formability index above R %_target,
D/ Outputting to a user the resulting modified finite element mesh with the resulting improved roll forming index R % and associated roll forming direction Rdir.

The skilled person will select an appropriate method to modify the finite element mesh in order to increase the roll formability index at step C of the above described method. For example a genetic algorithm can be used. For example a gradient base algorithm can be used.

For example, step C can be performed by iterating the following sub-steps (gradient base algorithm):
Cgrad-1: Applying the above described method to determine the roll forming index R % and the roll forming direction Rdir of the finite element mesh,
Cgrad-2: If the roll forming index R % computed at step Cgrad-1 is above R %_target proceeding to step D, if not proceeding to step Cgrad-3,
Cgrad-3: selecting at least part of the points forming the finite element mesh of the metallic part,
Cgrad-4: For each point selected at step Cgrad-3, determining a direction in which the computed roll formability index R % increases when moving said point in said direction,
Cgrad-5: generating a modified finite element mesh by moving all the points selected at step Cgrad-3 in the individual directions determined at step Cgrad-4 and proceeding back to step Cgrad-1,

For example, step C can be performed by iterating the following sub steps (genetic algorithm):
Cgen-1: generating an initial population of meshes consisting of random modifications of the initial finite element mesh,
Cgen-2: applying the above described method to determine the roll forming index R % and the roll forming direction Rdir of the meshes generated at the previous step,
Cgen-3: if at least one of the roll formability index computed at the previous step is above R %_target proceeding to step D, if not proceeding to step Cgen-4,
Cgen-4: selecting the meshes having the highest R % and generating a new population of meshes based on random combinations of the points of the selected meshes,
Cgen-5: modifying by small random increments the meshes generated at the previous step to generate a new population of meshes and proceeding to step Cgen-2,

By applying said method, it is possible to improve the roll forming index of a metallic part. This allows to modify the design of a part which is not possible to manufacture by roll forming into a design which is possible to be manufactured by roll forming, with the above described ensuing advantages.

The above described iterative method to improve the roll forming index of a part can be applied in combination with the above described computerized classification method, for example in one of the following ways:
increasing the roll forming index of a metallic part in order to change its classification from the not roll formable category to the roll formable with modifications category,
increasing the roll forming index of a metallic part in order to change its classification from the not roll formable category to the fully roll formable category,
increasing the roll forming index of a metallic part in order to change its classification from the roll formable with modifications category to the fully roll formable category.

What is claimed is:

1-10. (canceled)

11: A method for computerized determination of a roll formability index R %, and of a roll forming direction Rdir of a metallic part, comprising the following steps:
providing a finite element mesh of the metallic part;
computing for each element i of said mesh the vector 1, defined as the product of the normal vector of the element i by the surface area of the element I;
generating a matrix V of all vectors Vi;
performing a singular value decomposition of the matrix V in the form of
V=U·Σ·Y
extracting a smallest singular value Σmin=min(Σii) of the singular value decomposition;
computing a sum of a main diagonal of Σ, Σsum=Σ₁₁+Σ₂₂+Σ₃₃
computing a roll formability index of the part R % as being
$$R \% = 300 * ( \frac{1}{3} - \frac{\sum min}{\sum sum} )$$
and
extracting the roll forming direction Rdir as being the direction of the vector Ymin having the set of coordinates (Yi1, Yi2, Yi3) wherein i is the index for which Σii=Σmin.

12: A method for computerized classification of a metallic part into one of the following categories: roll-formable without modification, roll-formable with modifications, not roll-formable, said method comprising the following steps:
providing pre-determined thresholds Rfull and Rmod, respectively defined as the minimum roll formability index of fully roll formable parts and as the minimum roll formability index of parts which are roll formable with modifications;
computing the roll formability index R % of said metallic part using the method as recited in claim 11;
classifying the part into the fully roll formable category if R %>Rfull;
classifying the part into the roll formable with modifications category if Rfull≥R %≥Rmod,
classifying the part into the not roll formable category if R %<R_{mod}; and
outputting the results to a user.

13: The method as recited in claim 12 further comprising a method of determining the thresholds Rfull and Rmod prior to the providing of the pre-determined thresholds step, comprising the following steps:
providing a database MP of metallic parts;
providing an expert team, comprising at least one expert in sheet metal forming;
classifying the metallic parts of MP in three categories by the expert team: fully roll formable, roll formable with modifications, not roll formable applying the method as recited in claim 11 to determine the roll formability index R % of the metallic parts of MP;
generating a database D associating for each metallic part of MP the above described classification performed by the expert team and the above computed roll formability index R %;
computing the average and standard distribution of the R % values of D for each of the above described categories, said values being respectively known as A (fully roll formable), A (roll formable with modifications), A (not roll formable) for the average values and SD (fully roll formable), SD (roll formable with modifications), SD (not roll formable) for the standard deviation values;
generating gaussian probability distribution curves of R % for each of the above computed average and standard deviations, said curves being respectively known as G(fully roll formable), G(roll formable with modifications), G(not roll formable);
determining Rfull as being the R % value at the intersection between G(fully roll formable) and G(roll formable with modifications),
determining Rmod as being the R % value at the intersection between G(roll formable with modifications) and G(not roll formable); and
outputting the results to a user.

14: The method as recited in claim 12 wherein Rfull=83% and Rmod=60%.

15: A method to classify at least part of the metallic parts of an automotive vehicle into one of the following categories: roll-formable without modification, roll-formable with modifications, not roll-formable, said method comprising the following steps:
providing a database AV of the metallic parts;
applying the method as recited in claim 12 to the metallic parts of AV;
generating a database AVC associating the metallic parts of AV with their respective classification obtained in the above step; and
outputting the result to a user.

16: A method to manufacture a metallic part comprising the following steps:
classifying the metallic part in a category using the method as recited in claim 12; and
manufacturing the part using roll-forming if the part is classified in the roll formable category or in the roll formable with modification category.

17: A method to manufacture a metallic part using roll forming comprising the following steps:
providing a set N of n different possible designs for the metallic part;
applying the method as recited in claim 12 to the possible designs;
generating the sub-set P of the p possible designs falling into the category fully roll formable or roll formable with modifications; and
manufacturing the metallic part having a design included in sub-set P using roll forming.

18: A computerized method to modify the design of a part in order to increase the roll forming index of said part, comprising the following steps:
A/ Providing a finite element mesh of the metallic part;
B/ Providing a targeted roll formability index R %_target;
C/ Modifying the finite element mesh of the metallic part in order to increase the roll formability index above R %_target; and
D/ Outputting to a user the resulting modified finite element mesh with the resulting improved roll forming index R % and associated roll forming direction Rdir.

19: A computer program comprising instructions which, when the program is executed by a computer, cause the computer to carry out the method as recited in claim 11.

20: A computer-readable storage medium comprising instructions which, when executed by a computer, cause the computer to carry out the method as recited in claim 11.
